(19) United States
(12) Patent Application Publication
(10) Pub. No.: US 2014/0130948 A1
(43) Pub. Date: May 15, 2014

(54) TYRE PROVIDED WITH SOUND CHANNELS

(71) Applicants: MICHELIN RECHERCHE ET TECHNIQUE S.A., Granges-Paccot (CH); COMPAGNIE GENERALE DES ETABLISSEMENTS MICHELIN, Clermont-Ferrand (FR)

(72) Inventor: Antoine Paturle, Clermont-Ferrand (FR)

(21) Appl. No.: 14/128,712

(22) PCT Filed: Jun. 22, 2012
(86) PCT No.: PCT/FR2012/051438

§ 371 Date: Jan. 16, 2014

(30) Foreign Application Priority Data
Jun. 23, 2011 (FR) 1155540

(51) Int. Cl. B60C 11/24

(52) U.S. Cl. CPC B60C 11/24
USPC 152/154.2

(57) ABSTRACT

A tyre includes a tread with at most 30 channels distributed substantially evenly circumferentially about the tyre. Each channel is arranged so that, beyond a predetermined wear threshold, the channel satisfies the following conditions: (A) the channel opens into a tread pattern element of the tyre, and (B) the channel includes a mouth opening radially to outside of the tyre and is delimited by at least two edge corners that come into contact with a ground surface as the edge corners pass through a contact patch in which the tyre is in contact with the ground surface, in which a circumferential distance separating the edge corners from one another is greater than or equal to 2 mm, and preferably is greater than or equal to 4 mm. Before the predetermined wear threshold is reached, at least one of the conditions (A) and (B) is not met.

The present invention relates to a tyre provided with acoustic wear indicators. It is notably applicable, without being restricted thereto, to tyres for vehicles of any type, passenger or heavy goods.

As a tyre gradually runs along the ground, its tread that is in contact with the ground becomes worn away through friction. For obvious safety reasons it is important to replace a tyre before its tread wear becomes excessive and carries a risk of affecting its performance, particularly its grip on wet road surfaces.

Document FR 2 937 902 discloses a tyre comprising evenly distributed acoustic wear indicators consisting of acoustic cavities. Each cavity is delimited in part by two ribs positioned in the bottom of a groove of the tyre. Each cavity is configured in such a way that it is closed off in a substantially airtight manner by the ground so that it temporarily traps air as it passes through the contact patch in which the tyre is in contact with the ground. Under the effect of the deformation of the tyre in the contact patch, this air trapped in the cavity is compressed and then suddenly expands as it leaves the contact patch and the cavity therefore opens. This expansion of the air causes a characteristic noise which occurs only when the tyre has been worn beyond a certain threshold. Thus, even if the driver does not take the trouble to regularly make a visual inspection of the surface condition of his tyres, he is informed of the excessive wear of his tyres when, during driving, the characteristic noise is detected.

However, because of the way in which the ribs are arranged in the grooves, the acoustic cavities may impair the performance of the tyre as compared with a tyre that has no acoustic cavities, notably in terms of the ability of the grooves to remove water and therefore in terms of grip, chiefly because of the high number of ribs used to delimit the various cavities. The more advanced the state of wear of the tyre, the more this water-removal performance is impaired.

Further, the design of the tyre and of its mould is complicated, notably because of the high number of ribs used to delimit the various cavities. What happens, if an indicator is situated at the same position as a tread pattern element such as an open cut opening into the cavity delimited by the two ribs is that the cavity does not emit the expected noise because it is not closed in such a way as to be able to trap the air, and cannot therefore be used to detect wear. Further, if a rib is situated at the same position as a particular zone of the mould, such as the joint between two segments, the mould element used for moulding the rib is mechanically weakened because of the numerous openings and closings of the mould. If, in addition, an even distribution of indicators is to be observed, it then becomes difficult, if not impossible, to design empirically a tyre in which all the wear indicators satisfy these constraints of interaction with the tread pattern elements and mould elements.

It is a notable object of the invention to provide a tyre provided with acoustic wear indicators that have little influence on the performance and design of the tyre.

To this end, one subject of the invention is a tyre, comprising at most 30 channels substantially evenly circumferentially distributed about the tyre, each channel being arranged so that:
a) beyond a predetermined wear threshold it satisfies the following conditions:
   A: the channel opens into a tread pattern element of the tyre, preferably axially and/or into a circumferential groove, and
   B: the channel comprises a mouth opening radially to the outside of the tyre and delimited by at least two edge corners able to come into contact with the ground as they pass through the contact patch in which the tyre is in contact with the ground, the circumferential distance separating the edge corners from one another being greater than or equal to a value D, this value D being greater than or equal to 2 mm and preferably greater than or equal to 3 mm, and highly preferably greater than or equal to 4 mm
b) before this predetermined wear threshold is reached (SA1, SB1), it does not satisfy at least one of conditions A and B.
   In other words, there is a wear threshold higher than the predetermined threshold such that between the predetermined threshold and this higher threshold the tyre meets conditions A and B. In addition, there is a wear threshold not as high as the predetermined threshold and such that between this threshold that is not as high and the predetermined threshold, the tyre does not meet at least one of conditions A and B.

Such channels, as they pass through the contact patch in which the tyre is in contact with the ground, generate a characteristic noise as the tyre is running once the tyre wear threshold has been reached. The inventors are putting forward the hypothesis whereby this noise is generated by at least three distinct physical phenomena which have a synergistic effect.

On the one hand, once the wear threshold is reached, the noise is generated by the impact of each edge corner on the ground. Conversely, when the circumferential distance is below a value D, for example equal to 2 mm, or 2.5 mm, or 3 mm, or even 4 mm depending on the type of tyre, the edge corners come into contact with one another as they pass through the contact patch in which the tyre is in contact with the ground, because of the elasticity of the rubber. Because the mouth is then closed, the impact noise generated is very weak and difficult to detect and exploit.

On the other hand, once the wear threshold has been reached, the channel is covered by the ground as it passes through the contact patch. Thus covered, the channel forms a pipe which goes into resonance because of the vibrations caused by the aforementioned impact of the edge corners that form the edges of the pipe as the tyre runs along the ground. The resonance therefore causes a resonance noise characterized by a frequency range that is centred on a resonant frequency dependent on the length of the channel (a characteristic that is almost independent of the running speed) but the amplitude of which changes as a function of the cross section of the pipe which itself changes as a function of tyre wear.

Finally, the noise generated by the channel is amplified by acoustic coupling with the network of tyre tread patterns because the channel opens into a tread pattern element. What is meant by a tread pattern element is an element creating a void in the tread, for example a cut, groove or sipe, as opposed to a raised element, for example a block of rubber.

A circumferential distance separating the two edge corners means the mean distance between the two edge corners along the path that the channel follows. Thus, where the edge corners are substantially parallel to one another along the path along which the channel extends, the circumferential distance is the distance which, in the circumferential direction of the tyre, separates the two edge corners. Where the edge corners are not parallel to one another along the path followed by the channel, the circumferential distance separating the two edge corners is the mean, along the path along which the channel extends, of the distances which separate the two edge corners in the circumferential direction of the tyre.

In the invention, with each wear indicator consisting of a channel rather than of two projections forming a cavity that is closed to air as it passes through the contact patch in which the tyre is in contact with the ground, the potential loss of performance caused by the indicators is considerably reduced, or the ability of the tyre to remove water is even improved.

Further, because of the lower number of channels, the tyre and its mould also become easier to design because, since each indicator does not form a closed cavity, there is no need to avoid interactions with the other tyre tread pattern elements or mould elements.

Even if the driver does not take the trouble to visually inspect the surface condition of his tyres on a regular basis, he will be informed of the crossing of the wear threshold when, in running, the characteristic noise is detected.

Further, since the channels are evenly circumferentially distributed about the tread of the tyre, the noise emitted after the wear threshold has been crossed has notable frequency characteristics. Specifically, spectral analysis of the noise emitted once the wear threshold has been exceeded reveals, in the frequency domain, a Dirac comb that can easily be identified from all the parasitic noises such as the road noise of the tyre, the wind, the noise of the engine or the noise of the associated drivetrain. It will be possible to use a method as described in application PCT/FR2010/052584 for detecting the wear of the tyre according to the invention. As an alternative, other methods may be used.

For preference, use is made of one or more detection microphones connected to a processing unit able to discern the noise from the running noise, the wind, the noise of the engine or the noise of the associated drivetrain and to inform the driver that his tyres are worn.

What is meant by “channels that are evenly circumferentially distributed” is that each channel is situated substantially at the same angular distance from the two channels adjacent to it, whether or not these are circumferentially aligned. In other words, the evenly distributed channels have the same angular separation one from the next.

For preference, the circumferential distance separating the edge corners is less than or equal to 30 mm.

Beyond a certain circumferential distance, the tyre has too high a level of tread patterns to ensure sufficient rigidity.

Advantageously, in the case of a tyre for a vehicle of the passenger car type, the circumferential distance separating the edge corners is comprised between 12 and 16 mm inclusive of end points. In the case of a tyre for a vehicle of the heavy goods type, the circumferential distance separating the edge corners is comprised between 4 and 8 mm inclusive of end points.

Such a circumferential distance makes it possible to generate a noise that is loud enough while at the same time minimizing the influence that the channels have on tyre performance.

For preference, each channel opens axially into a circumferential groove.

More preferably still, with the tyre comprising two circumferential grooves, each channel opens into the two grooves, preferably axially.

Because the channels open into the grooves, the noise generated is amplified as compared with channels arranged elsewhere in the tread. The noise generated is amplified by a phenomenon of acoustic coupling between the resonance of the pipes formed by the channels and the resonance of the pipes formed by the grooves.

Advantageously, each channel has two mouths opening axially into the grooves, the two mouths being substantially axially aligned.

For preference, each channel extends along a path that is substantially rectilinear and parallel to the axial direction of the tyre.

The longer the edge corner and the more perpendicular the edge corner is to the circumferential direction, the higher the acoustic intensity of the noise of impact. Thus, when each channel extends along a path that is substantially rectilinear and parallel to the axial direction of the tyre, all of each edge corner simultaneously strikes the ground as it passes through the contact patch in which the tyre is in contact with the ground and this makes it possible to increase the volume of the impact noise.

According to an optional feature of the tyre, beyond the threshold, each channel and the tread pattern element delimit a space that is open to the air as the channel passes through the contact patch in which the tyre is in contact with the ground.

The resonance noise of the pipe can thus spread through the network of tyre tread patterns.

Optionally, the tyre comprises between 2 and 12 channels, inclusive of end points, typically in the case of a tyre for a vehicle of the heavy goods type and between 2 and 8 channels, inclusive of end points, typically in the case of a tyre for a vehicle of the passenger car type.

In one embodiment, each channel is closed radially towards the outside of the tyre by a mass of rubber of the tyre when the tyre is new.

In another embodiment, each channel opens radially to the outside of the tyre when the tyre is new.

For preference, each channel comprises first and second radial portions arranged so that the second radial portion extends the first radial portion radially towards the outside of the tyre, and such that:
the first radial portion, considered as a channel, satisfies condition B;
the second radial portion, considered as a channel, does not satisfy condition B.

For preference, the circumferential distance separating the edge corners from one another for the second radial portion is less than 0.8 D, and highly preferably less than 0.6 D. Typically, this distance is less than 2 mm, or less than 1.8 mm, and preferably less than 1.5 mm.

For preference, the circumferential distance between any two points of the first radial portion corresponding to one and the same wear level and circumferentially facing one another is greater than or equal to D, and preferably greater than or equal to 4 mm. In other words, this distance between edge corners advantageously covers any local distance, not only the mean distance.

For preference, the circumferential distance between any two points of the second radial portion corresponding to one and the same wear level and circumferentially facing one another is less than D, and preferably less than 2 mm. In other words, this distance between edge corners advantageously covers any local distance, not just the mean distance.

Advantageously, each portion has, in radial plane, a rectangular shape the cross section of which is substantially constant in the axial direction.

Advantageously, each channel is arranged in such a way that beyond a wear threshold that is more advanced than the threshold, it at most only satisfies one of conditions A and B.

Thus, beyond the most advanced threshold, the channels no longer generate the characteristic noise and therefore no longer act as acoustic wear indicators. A range of wear can thus be detected.

In one embodiment, the tyre comprises first and second sets of at most 30 channels, the channels of each first and second set being evenly circumferentially distributed about the tyre, each channel of each first and second set being arranged in such a way that, beyond at least predetermined first and second wear thresholds respectively, the second threshold being more advanced than the first threshold, it satisfies conditions A and B.

The channels of the first set form acoustic wear indicators indicating that the tyre has worn beyond the first threshold. The channels of the second set form acoustic wear indicators indicating that the tyre has worn beyond the second threshold.

By differentiating between certain characteristics of the channels of the first and second sets, notably the number of channels in each set, it is possible to differentiate between the characteristics of the noise generated by the channels beyond each threshold. Thus, for a given speed, beyond a given threshold, the noise generated by the channels associated with this given threshold displays certain characteristics, whereas beyond another threshold, the noise generated by the channels associated with this other threshold displays other characteristics.

For preference, each channel of each first and second set is arranged in such a way that, beyond a third and fourth wear threshold respectively more advanced than each first and second threshold, it satisfies at most only one of conditions A and B.

It is thus possible to detect two ranges of wear. These ranges may be separate, i.e. have no wear value in common, or alternatively may overlap, i.e. may have wear values in common.

The invention will be better understood for reading the following description, given solely by way of non limiting example and made with reference to the drawings in which:

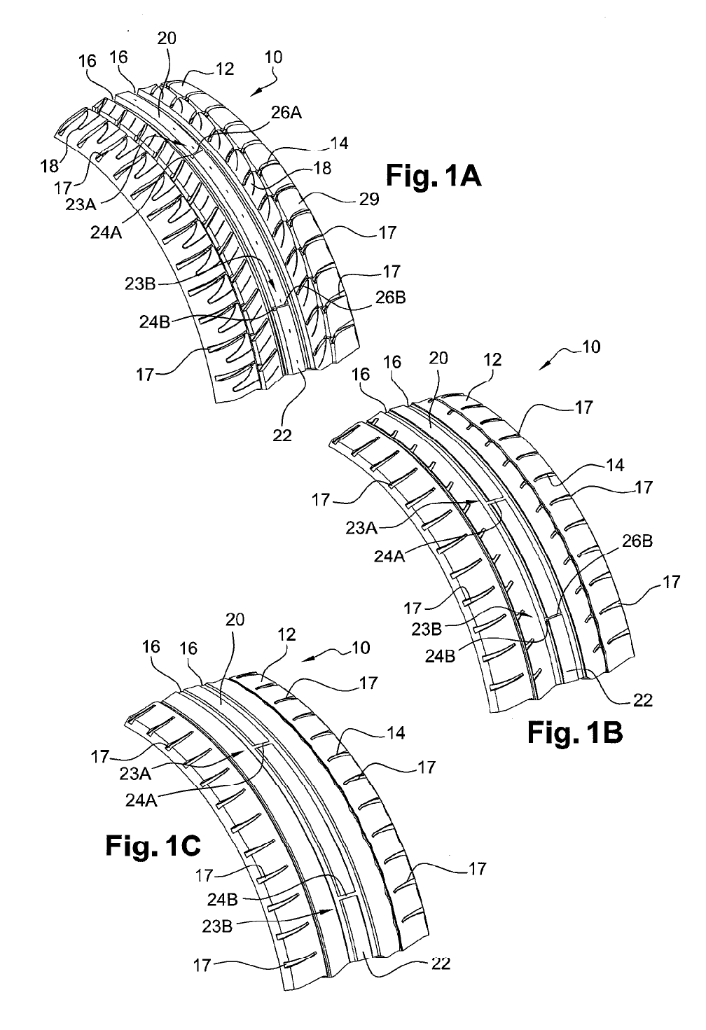

FIG. 1A illustrates a new tyre according to a first embodiment;

FIGS. 1B and 1C illustrate the tyre of FIG. 1A worn respectively beyond first and second wear thresholds;

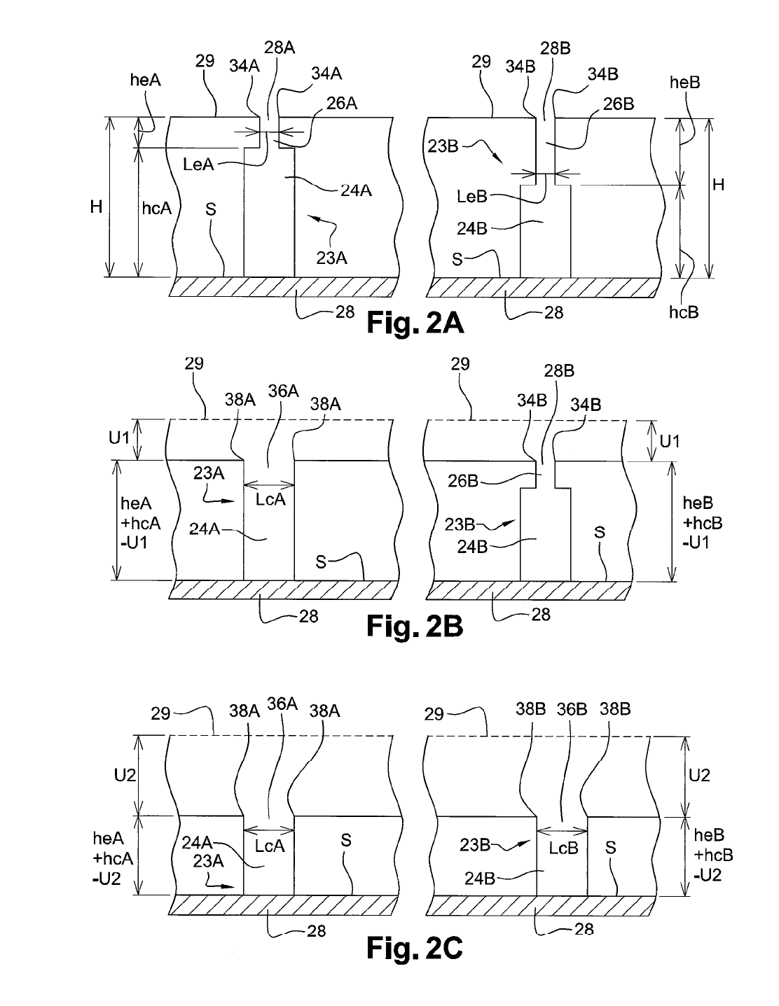

FIG. 2A is a view in cross section of the tyre of FIG. 1A on a radial mid plane of the tyre;

FIGS. 2B and 2C are similar to the view of FIG. 2A of the tyres of FIGS. 1B and 1C respectively;

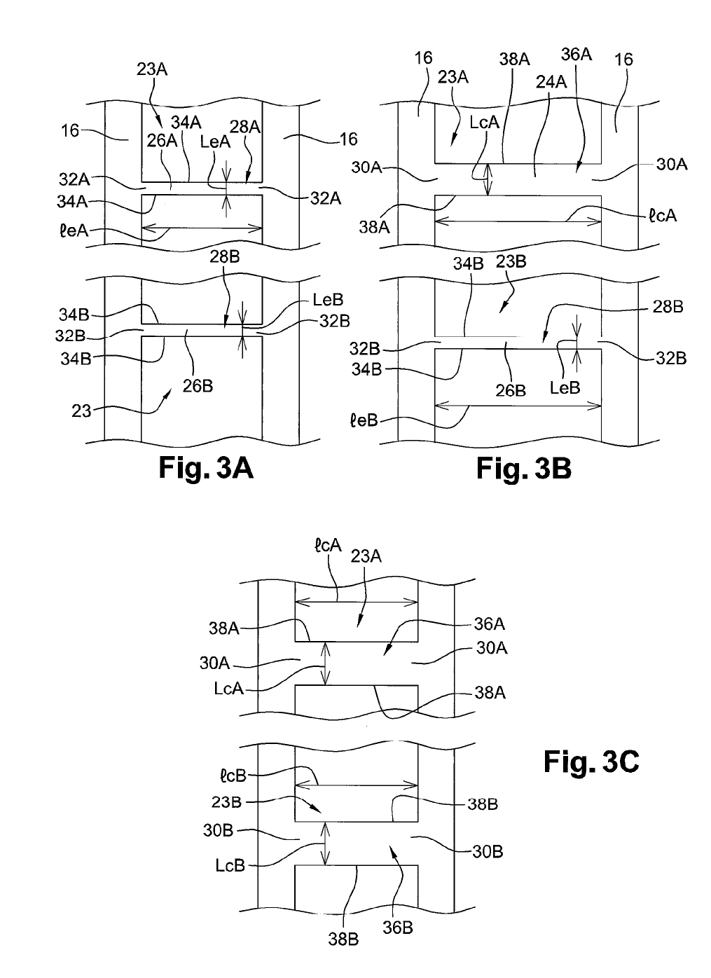

FIG. 3A is a plan view of the tyre of FIG. 1A;

FIGS. 3B and 3C are views similar to the view of FIG. 3A of the tyres of FIGS. 1B and 1C respectively;

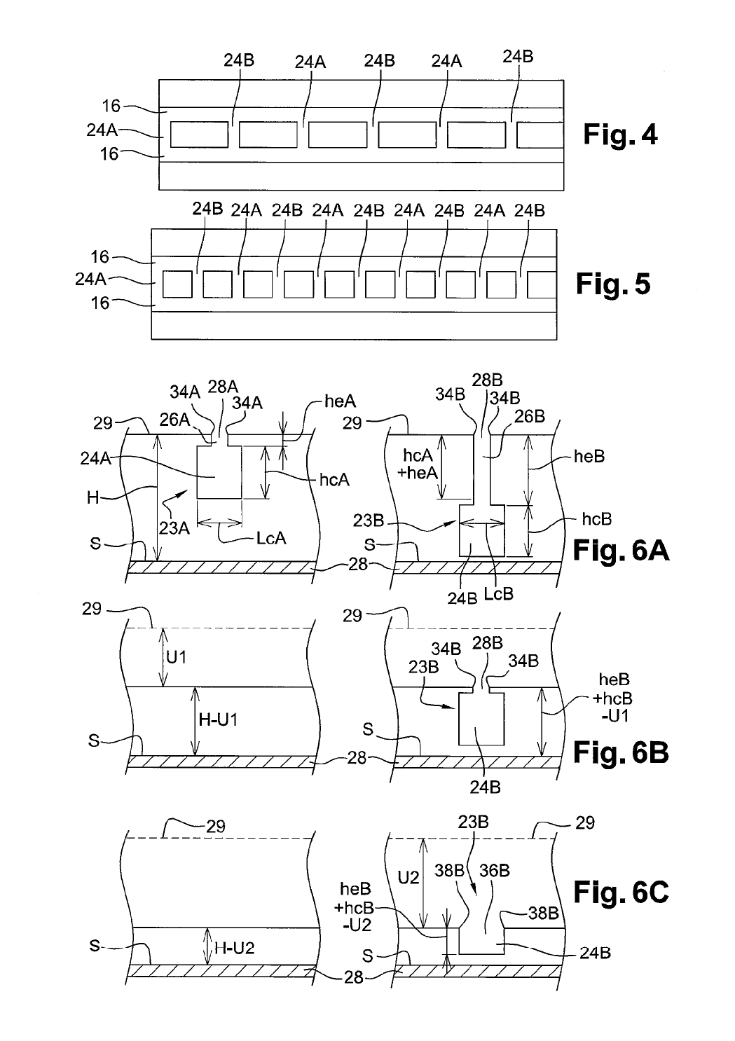

FIG. 4 schematically illustrates a developed tread of the tyre of FIGS. 1A, 1B and 1C;

FIG. 5 schematically illustrates a developed tread of a tyre according to a second embodiment;

FIGS. 6A, 6B and 6C are views similar respectively to the views of

FIGS. 2A, 2B and 2C, of a tyre according to a third embodiment;

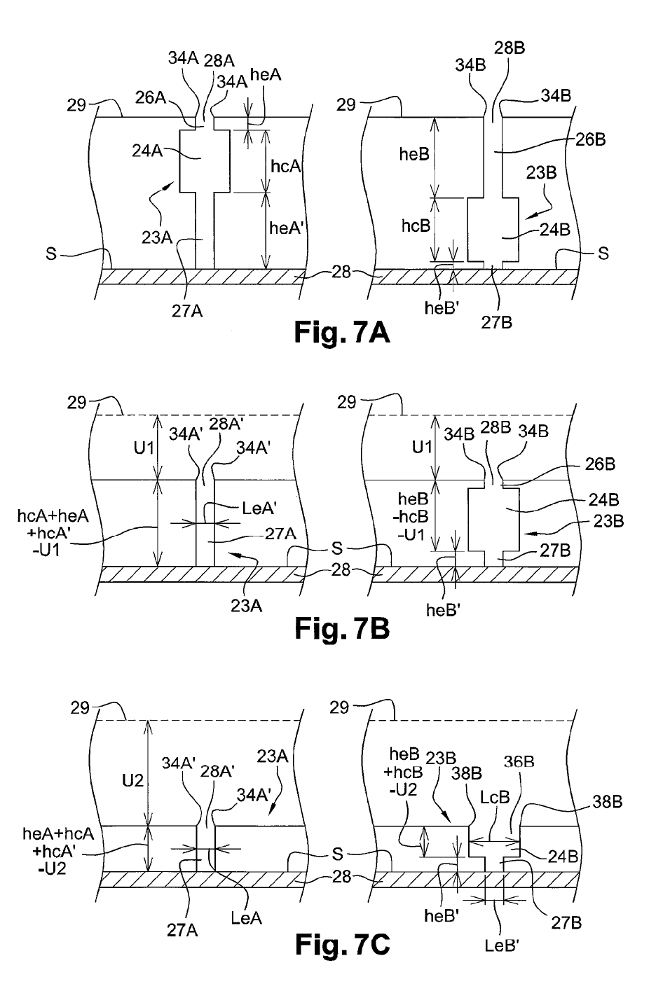

FIGS. 7A, 7B and 7C are views similar respectively to the views of

FIGS. 2A, 2B and 2C of a tyre according to a fourth embodiment;

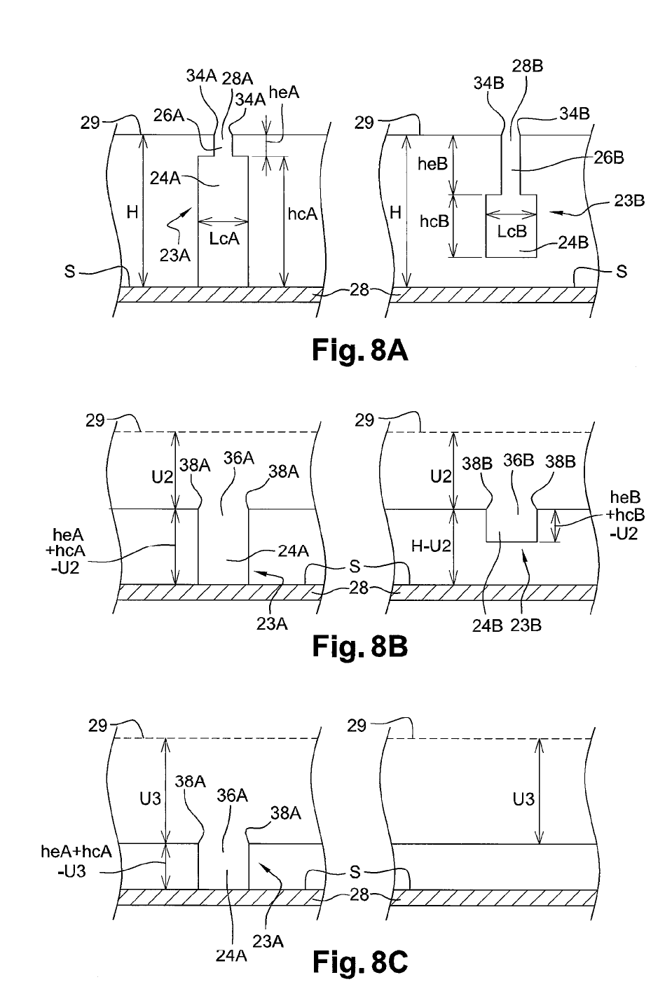

FIGS. 8A, 8B and 8C are views similar respectively to the views of

FIGS. 2A, 2B and 2C of a tyre according to a fifth embodiment;

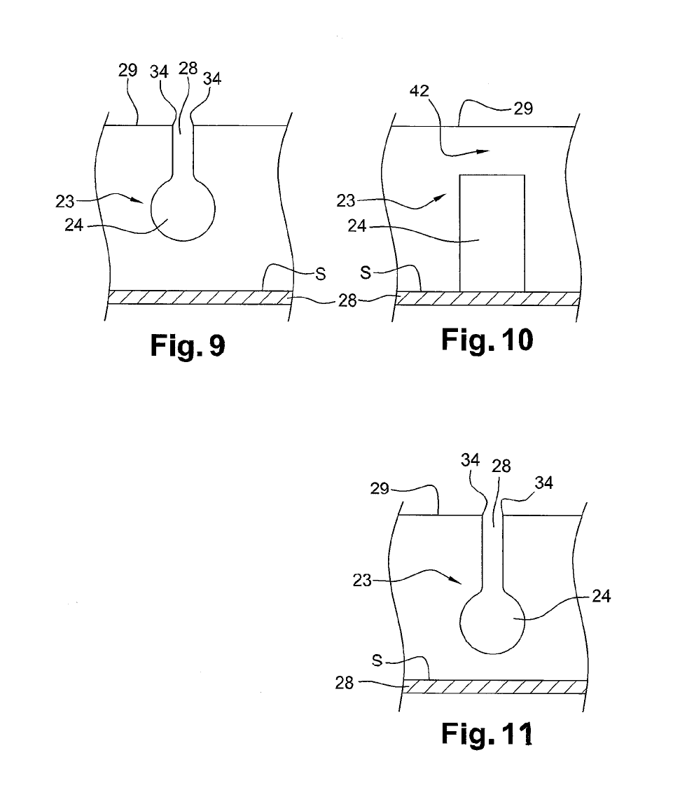

FIGS. 9 to 12 are views similar to those of FIGS. 2A, 6A, 7A and 8A according to sixth, seventh, eighth and ninth embodiments;

FIGS. 13 to 15 are views similar to that of FIG. 3C of tyres according to tenth, eleventh and twelfth embodiments respectively.

FIG. 1A depicts a tyre in the new condition according to a first embodiment of the invention, denoted by the general reference 10. The tyre 10 is intended for a passenger vehicle. The tyre 10 substantially exhibits symmetry of revolution about an axis.

The tyre 10 comprises a tread 12 of substantially toroidal shape and the external surface of which is provided with tread pattern elements 14. In order to minimize running or road noise, notably the whining noise associated with the periodicity of the tread pattern of the tyre 10, the tread pattern usually comprises several distinct circumferential portions. Each circumferential portion bears a pattern chosen from a group of several distinct patterns, generally three or four patterns. The tread pattern is therefore made up of a non-periodic arrangement of these patterns, in order to prevent the tyre 10 from whining.

The elements 14 comprise grooves 16, cuts 17 and sipes 18. Because of their shallow depth, the sipes 18 are visible only in FIG. 1. The tyre 10 comprises two circumferential and parallel grooves 16 cut into the surface of the tyre, with a predetermined depth H when the tyre 10 is new. The depth H of these grooves 16 is of the order of 8 mm and their width is of the order of 10 mm.

The tyre 10 comprises a mass of rubber 20 arranged between the two grooves 16. The mass of rubber 20 forms a belt 22 extending circumferentially around the tyre 10.

The tyre 10 comprises two sets E1, E2 respectively comprising channels 23A, 23B. Each channel 23A, 23B opens axially into at least one circumferential groove 16, and in this instance into both circumferential grooves 16.

FIGS. 2A and 3A depict two channels 23A, 23B formed in the tread 12, in this instance in the belt 22. In this figure and the next figures, the dimensions have been altered arbitrarily for the sake of clarity.

Each channel 23A, 23B respectively comprises first 24A, 24B and second 26A, 26B radial portions. Each portion 26A, 26B extends each portion 24A, 24B radially towards the outside of the tyre. Each portion 26A, 26B respectively comprises a mouth 28A, 28B opening radially to the outside of the tyre 10. Each channel 23A, 23B extends radially from the top S of a carcass ply 28 of the tyre 10 as far as the surface 29 via which the tread 12 makes contact with the ground. The distance separating the top S and the surface 29 is substantially equal to the height H of the grooves 16. Each channel 23A, 23B opens radially to the inside of the tyre 10 at the top S.

Each portion 24A, 24B, 26A, 26B respectively comprises two mouths 30A, 30B, 32A, 32B opening axially into the two grooves 16. Each channel 23A, 23B extends axially between the two grooves 16. Each channel 23A, 23B extends along a path that is substantially rectilinear and parallel to the axial direction of the tyre 10. The mouths 30A, 30B and 32A, 32B are respectively substantially axially aligned with one another.

Each portion 24A, 24B and 26A, 26B has, in a radial plane of section, a cross section that is constant in the axial direction and of rectangular shape.

Each mouth 28A, 28B is respectively delimited by two edge corners 34A, 34B. The dimension LeA, LeB of each portion 26A, 26B in the circumferential direction, i.e. the circumferential distance separating the two edge corners 34 from one another, also referred to as width, is less than or equal to 1 mm.

The dimension hcA of each portion 24A in the radial direction, also referred to as height, is greater than the height hcB of each portion 24B. The height heA of each portion 26A is less than the height heB of each portion 26B.

The dimension leA, leB of each portion 26A, 26B in the axial direction, also referred to as length, is substantially equal to the length lcA, lcB of each portion 24A, 24B. In this embodiment heA+hcA=heB+hcB=H

FIGS. 1B, 2B and 3B depict the tyre 10 worn beyond a threshold SA1, i.e. after a radial thickness U1>SA1=heA of tread 12 has disappeared through wear.

Beyond the threshold SA1, each portion 24A comprises a mouth 36A opening radially towards the outside of the tyre 10. Each portion 24A opens into the two grooves 16 via the mouths 30A.

The wear of the tyre 10 depicted in FIGS. 1B, 2B and 3B is above the threshold SA1, i.e. greater than the distance which, when the tyre 10 is new, separates the mouth 36A of the portion 24A and the surface 29. Thus, beyond the threshold SA1, each channel 23A has a height heA+hcA−U1 less than the height hcA.

Beyond the threshold SA1, each channel 23A and the grooves 16 delimit a space that is open to the air as the channel 23A passes through the contact patch in which the tyre is in contact with the ground.

Beyond the threshold SA1, each mouth 36A is delimited by two edge corners 38A able to come into contact with the ground as they pass through the contact patch in which the tyre 10 is in contact with the ground. The width LcA of each channel 23A, i.e. the circumferential distance separating the two edge corners 38 from one another, is greater than or equal to 2 mm and preferably 4 mm. LcA is also less than or equal to 30 mm. In this particular instance, LcA is comprised between 12 and 16 mm, inclusive of end points, and measures 14 mm.

FIGS. 1C, 2C and 3C depict the tyre 10 worn beyond a threshold SB1 that is further advanced than the threshold SA1, i.e. after a radial thickness U2>SB1=heB of tread 12 has disappeared through wear.

Beyond the threshold SB1, each channel 23B comprises a mouth 36B opening radially to the outside of the tyre 10. Each channel 23B opens axially into the two grooves 16 via the mouths 30B. Each channel 23A also opens radially towards the outside of the tyre via the mouth 36A and axially into the two grooves 16 via the mouths 30A.

The wear of the tyre 10 depicted in FIGS. 1C, 2C and 3C is above the threshold SB1, namely above the distance which, when the tyre 10 is new, separates the mouth 36B of the portion 24B and the surface 29. Thus, beyond the threshold SB1, each channel 23A, 23B has a height heB+hcB−U2 less than the height hcB.

Beyond the threshold SB1, each channel 23A, 23B and the grooves 16 delimit a space that is open to the air as the channel 23A, 23B respectively passes through the contact patch in which the tyre is in contact with the ground.

Beyond the threshold SB1, each mouth 36B is delimited by two edge corners 38B able to come into contact with the ground as they pass through the contact patch in which the tyre 10 is in contact with the ground.

Beyond the threshold SB1, each width LcA, LcB of each channel 23A, 23B, i.e. the circumferential distance respectively separating the two edge corners 38A, 38B from one another, is greater than or equal to 2 mm and preferably 4 mm. Each width LcA, LcB is also less than or equal to 30 mm. In this particular instance, each width LcA, LcB is comprised between 12 and 16 mm inclusive of end points and LcA=LcB=14 mm.

Each channel 23A, 23B is arranged in such a way that, beyond a respective threshold SA2, SB2 which is more advanced than each threshold SA1, SB1 respectively, it satisfies at most only one of the following conditions:
the channel 23A, 23B opens into at least one of the grooves 16 (condition A), and
the channel 23A, 23B comprises a mouth 36A, 36B opening radially towards the outside of the tyre 10 and delimited by at least two edge corners 38A, 38B able to come into contact with the ground as they pass through the contact patch in which the tyre 10 is in contact with the ground, the circumferential distance LcA, LcB separating the edge corners 38A, 38B from one another being greater than or equal to 2 mm and preferably 4 mm (condition B).

When the tyre 10 is displaying wear greater than the thickness H of the tread 12 (not depicted), the tyre is worn beyond the wear threshold SA2, SB2. In this embodiment SA2=SB2. This wear corresponds to a radial thickness U3>H of tread 12 having disappeared.

Beyond the threshold SA2, SB2 and when the tyre 10 is displaying the wear U3, none of the channels 23A, 23B satisfies condition A, or condition B. In effect, the channels 23A and 23B disappear.

It will be noted that whatever the wear of the tyre 10, each portion 26A, 26B satisfies at most only one of conditions A and B, in this instance condition A.

FIG. 4 illustrates the circumferential distribution of the channels 23A, 23B. The tyre 10 comprises at most 30 channels 23A, 23B, namely between 2 and 30 channels, inclusive of end points. In this particular instance, the tyre 10 comprises between 2 and 8 channels, inclusive of end points, here 6 channels. The set E1 comprises three channels 23A. The set E2 comprises three channels 23B. As an alternative, the numbers of channels 23A, 23B of the sets E1, E2 differ from one another.

The channels 23A are substantially evenly circumferentially distributed about the tyre 10, as are the channels 23B. Moreover, all the channels are evenly circumferentially distributed about the tyre. All the channels 23A are identical. All the channels 23B are identical.

FIG. 5 schematically depicts a tread 12 of a tyre according to a second embodiment. Elements analogous to those depicted in the preceding figures are denoted by identical references.

The tyre 10 is intended for a vehicle of the heavy goods type. Unlike the tyre according to the first embodiment, the tyre 10 comprises between 2 and 12 channels inclusive of end points, in this instance 10 channels. The set E1 comprises five channels 23A. The set E2 comprises five channels 23B.

In this embodiment, the circumferential distance LcA, LcB separating the edge corners 38A, 38B from one another is comprised between 4 and 8 mm inclusive of end points.

FIGS. 6A, 6B and 6C depict the channels 23A, 23B of a tyre according to a third embodiment. Elements analogous to those depicted in the preceding figures are denoted by identical references.

In this embodiment, SB2 is more advanced than SA2.

Unlike the tyre according to the first embodiment, each channel 23A, 23B extends radially partially between the top S and the surface 29 for contact with the ground. In other words, heA+hcA<H et heB+hcB<H. Each channel 23A, 23B does not open onto the top S.

FIG. 6B depicts the tyre 10 worn beyond the threshold SA2, i.e. after a radial thickness U1>SA2=heA+hcA of the tread 12 has disappeared. However, the wear U1 is below the threshold SB1=heB.

Beyond the threshold SA2 and when the tyre is displaying the wear U1, each channel 23A has disappeared and no channel 23A satisfies condition A or B.

The threshold SB1 is more advanced than the threshold SA2, namely heA+hcA<heB. Thus, when the tyre 10 is displaying wear corresponding to the disappearance of a radial thickness U1 meeting U1>SA1=heA and U1<SB1=heB, no channel 23A, 23B satisfies conditions A and B.

FIG. 6C depicts the tyre 10 worn beyond the threshold SB1, namely after a radial thickness U2>SB1=heB of the tread 12 has disappeared.

Beyond the threshold SB1 and when the tyre is displaying the wear U2, each channel 23B satisfies the two conditions A and B.

When the tyre is worn beyond the threshold SB2 (not depicted), namely after a radial thickness U1>SB2=heB+hcB of the tread 12 has disappeared, since all of the channels 23B have disappeared, no channel 23B satisfies condition A or B.

FIGS. 7A, 7B and 7C depict the channels 23A, 23B of a tyre according to a fourth embodiment. Elements analogous to those depicted in the preceding figures are denoted by identical references.

Unlike the tyre according to the third embodiment, each channel 23A and 23B respectively comprises three portions 24A, 26A, 27A and 24B, 26B, 27B. Each portion 24A, 24B is interposed radially between the portions 26A, 27A and 26B, 27B respectively.

Each portion 27A, 27B has a length leA′, leB′ and a width LeA′, LeB′ which are substantially equal to those of the portions 26A, 26B. Each portion 27A, 27B has a height heA′, heB′. Whatever the wear of the tyre 10, each portion 27A, 27B satisfies at most just one of conditions A and B, in this instance condition A.

Unlike the tyre according to the third embodiment, beyond the threshold SA2, the circumferential distance LeA′ separating the edge corners 34A′ from one another is less than or equal to 4 mm and even 2 mm. None of the channels 23A therefore satisfies condition B.

Similarly, beyond the threshold SB2 (not depicted), the circumferential distance LeB′ separating the edge corners 34B′ from one another is less than or equal to 4 mm and even 2 mm. None of the channels 23B therefore satisfies condition B.

FIGS. 8A, 8B and 8C depict the channels 23A, 23B of a tyre according to a fifth embodiment. Elements analogous to those depicted in the preceding figures are denoted by identical references.

Unlike the tyre according to the third embodiment, each channel 23A extends from the top S as far as the surface 29 of the tread 12 that makes contact with the ground. In this embodiment, SA2 is therefore more advanced than SB2.

Thus, for wear corresponding to the disappearance of a radial thickness U1 meeting the condition U1>SA1=heA and U1<SB1=heB (not depicted), only each channel 23A satisfies conditions A and B.

FIG. 8B depicts the tyre 10 worn beyond the threshold SB1, namely after a radial thickness U2>SB1=heB of the tread 12 has disappeared. However, the wear U2 is below the threshold SB2=heB+hcB.

Beyond the threshold SB1 and when the tyre is displaying the wear U2, each channel 23A, 23B satisfies conditions A and B.

FIG. 8C depicts the tyre 10 worn beyond the threshold SB2, namely after a radial thickness U3>SB2=heB+hcB of the tread 12 has disappeared.

Beyond the threshold SB2 and when the tyre 10 is displaying the wear U3, only each channel 23A satisfies conditions A and B. Because the channels 23B have disappeared, no channel satisfies condition A or B.

FIGS. 9 to 12 depict new tyres according to various embodiments. Elements analogous to those depicted in the preceding figures are denoted by identical references.

The tyre 10 according to the sixth embodiment in FIG. 9 comprises channels 23 comprising a portion 24 which, in the radial plane of section, has a teardrop-shaped cross section.

The tyre 10 according to the seventh embodiment in FIG. 10 comprises channels 23 closed radially towards the outside of the tyre 10 by a mass of rubber 42 of the tyre which mass is interposed radially between each channel 23 and the surface 29. Thus, when the tyre is displaying wear below the threshold SA1, each channel 23 does not satisfy condition B.

The tyre 10 according to the eighth embodiment in FIG. 11 comprises channels 23 comprising a portion 24 which, in the radial plane of section, has a circular cross section.

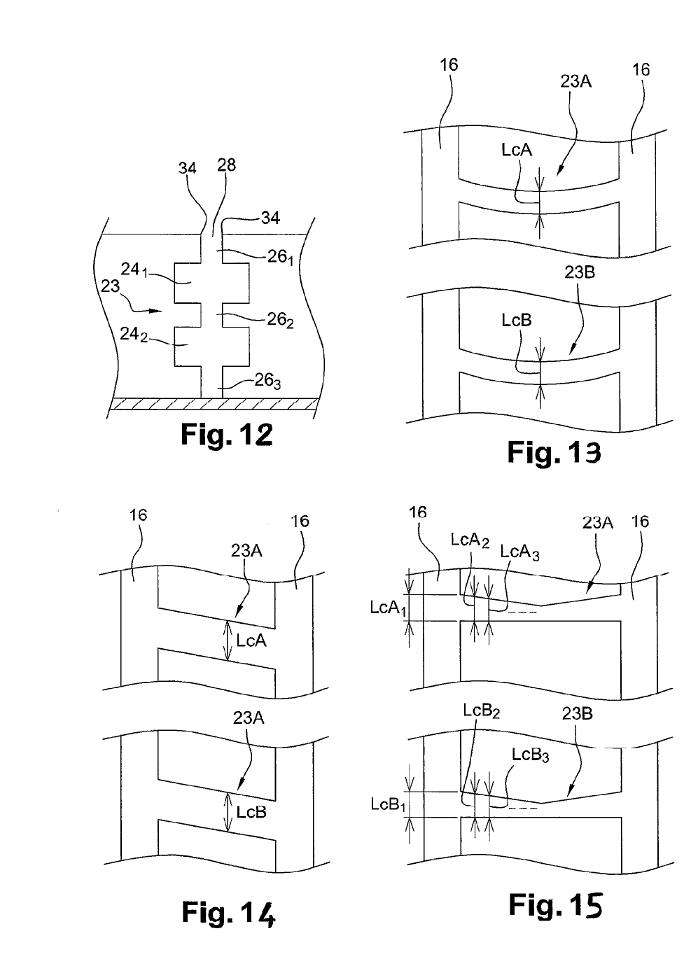

The tyre 10 according to the ninth embodiment in FIG. 12 comprises channels 23 arranged in such a way that beyond the threshold SA1 and before the threshold SA2 they satisfy conditions A and B. The channels 23 are also arranged in such a way that beyond a threshold SA3 that is more advanced than the threshold SA2, the channels 23 satisfy conditions A and B and so that beyond the threshold SA4 that is more advanced than the threshold SA3, the channels 23 satisfy at most one of conditions A and B.

In this particular instance, the channel 23 comprises two radial portions 24₁, 24₂ along which conditions A and B are satisfied and three radial portions 26₁, 26₂, 26₃ along which at most one of conditions A and B is satisfied. The portion 26₁ corresponds to wear below SA1, the portion 24₁ corresponds to wear comprised between SA1 and SA2, the portion 26₂ corresponds to wear comprised between SA2 and SB1, the portion 24₂ corresponds to wear comprised between SB1 and SB2 and the portion 26₃ corresponds to wear greater than SB2.

FIGS. 13 to 15 depict channels 23A, 23B of tyres according to various embodiments. Elements analogous to those depicted in the preceding figures are denoted by identical references.

The tyre 10 according to the tenth embodiment in FIG. 13 comprises channels 23A, 23B extending in a non-rectilinear, and in this instance curved, path.

The tyre 10 according to the eleventh embodiment in FIG. 14 comprises channels 23A, 23B extending in a substantially rectilinear path in a direction that makes a non-zero angle with the axial direction of the tyre 10. The cross section of the channels 23A, 23B in a plane of section perpendicular to the direction in which the channels 23A, 23B extend is substantially constant.

The tyre 10 according to the twelfth embodiment in FIG. 15 comprises channels 23A, 23B in which the distance separating the edge corners 38A, 38B from one another is not constant in the axial direction. Thus, the circumferential distance LcA is calculated as the mean, in the axial direction, of the circumferential distances LcA₁, LcA₂, LcA₃, etc which, for a given axial dimension, separate two circumferentially aligned points of the edge corners 38A. The same approach is used for the circumferential distance LcB.

The invention is not restricted to the embodiments described hereinabove.

Specifically, the features of the various embodiments described hereinabove can be mixed provided they are compatible with one another.

All the channels of one and the same set are not necessarily identical. Specifically, all that is required is for each channel to satisfy conditions A and B, whatever the other characteristics of the channel, notably whatever its overall shape.

Each channel could have a cross section that varies in the axial direction.

The tread pattern element may be a cut, preferably forming a network with other tread pattern elements of the tyre.

1-17. (canceled)

18. A tyre, comprising a tread that includes at most 30 channels distributed substantially evenly circumferentially about the tyre, each channel being arranged so that:
beyond a predetermined wear threshold, the channel satisfies condition A and condition B, wherein:
in the condition A, the channel opens into a tread pattern element of the tyre, wherein the channel being an axial channel that opens into a circumferential groove is preferable, and
in the condition B, the channel includes a mouth that opens radially to outside of the tyre and is delimited by at least two edge corners that come into contact with a ground surface as the edge corners pass through a contact patch in which the tyre is in contact with the ground surface, a circumferential distance separating the edge corners from one another being greater than or equal to D, in which D is greater than or equal to 2 mm, and in which D being greater than or equal to 4 mm is preferable, and
before the predetermined wear threshold is reached, at least one of the condition A and the condition B is not satisfied.

19. The tyre according to claim 18, wherein D is equal to 2 mm.

20. The tyre according to claim 18 or claim 19,
wherein the tread further includes two circumferential grooves, and
wherein each channel opens into the two circumferential grooves, with the channels axially opening into the two circumferential grooves being preferable.

21. The tyre according to claim 20, wherein each channel has two mouths opening axially into the two circumferential grooves, the two mouths being substantially axially aligned.

22. The tyre according to claim 21, wherein each channel extends along a path that is substantially rectilinear and parallel to an axial direction of the tyre.

23. The tyre according to claim 18 or claim 19, wherein each channel includes first and second radial portions arranged so that the second radial portion extends from the first radial portion radially towards outside of the tyre, such that:
the first radial portion is a channel and satisfies the condition B, and
the second radial portion is considered a channel and does not satisfy the condition B.

24. The tyre according to claim 23, wherein:
a circumferential distance between any two points of the first radial portion corresponding to a same wear level and circumferentially facing one another is greater than or equal to a first value, in which the first value being greater than or equal to 4 mm is preferable, and
a circumferential distance between any two points of the second radial portion corresponding to a same wear level and circumferentially facing one another is less than a second value, in which the second value being less than 2 mm is preferable.

25. The tyre according to claim 24, wherein each radial portion has, in a radial plane, a rectangular shape with a cross section that is substantially constant in an axial direction.

26. The tyre according to claim 18 or claim 19, wherein each channel is closed radially towards outside of the tyre by a mass of rubber that is interposed radially between the channel and a surface of the tyre.

27. The tyre according to claim 18 or claim 19, wherein the circumferential distance separating the edge corners is less than or equal to 30 mm.

28. The tyre according to claim 27, wherein the circumferential distance separating the edge corners is between 12 and 16 mm, inclusive of end points.

29. The tyre according to claim 27, wherein the circumferential distance separating the edge corners is between 4 and 8 mm, inclusive of end points.

30. The tyre according to claim 18 or claim 19, in which, beyond the predetermined wear threshold, each channel and the tread pattern element delimit a space that is open to air as the channel passes through the contact patch in which the tyre is in contact with the ground surface.

31. The tyre according to claim 18 or claim 19, wherein the channels total in number between 2 and 12, inclusive of end points, in which the number being between 2 and 8, inclusive of end points, is preferable.

32. The tyre according to claim 18 or claim 19, wherein each channel is arranged such that, beyond a wear threshold that is more advanced than the predetermined wear threshold, at most only one of the condition A and the condition B is satisfied.

33. The tyre according to claim 18 or claim 19, wherein the at most 30 channels are grouped in first and second sets, with the channels of each first set and each second set being distributed evenly circumferentially about the tyre, each channel of each first set and each second set being arranged in such a way that, beyond predetermined first and second wear thresholds, respectively, the second wear threshold being more advanced than the first wear threshold, the conditions A and B are satisfied.

34. The tyre according to claim 33, wherein each channel of each first set and each second set is arranged in such a way that, beyond a third wear threshold and a fourth wear threshold, respectively, both more advanced than the first wear threshold and the second threshold, at most only one of the conditions A and B is satisfied.
